(19) United States
(12) Patent Application Publication
(10) Pub. No.: US 2026/0117689 A1
(43) Pub. Date: Apr. 30, 2026

(54) EXHAUST GAS PURIFICATION DEVICE

(71) Applicant: TOYOTA JIDOSHA KABUSHIKI KAISHA, Toyota-shi (JP)

(72) Inventors: Hiromu SASAKI, Susono-shi (JP); Hiroyoshi UEDA, Chigasaki-shi (JP); Teruaki HAIBARA, Ashigarakami-gun (JP)

(73) Assignee: TOYOTA JIDOSHA KABUSHIKI KAISHA, Toyota-shi (JP)

(21) Appl. No.: 19/363,576

(22) Filed: Oct. 20, 2025

(30) Foreign Application Priority Data
Oct. 25, 2024 (JP) 2024-188006

(51) Int. Cl. F01N 3/28; B01D 53/94

(52) U.S. Cl. CPC F01N 3/2803; B01D 53/94; B01D 2258/01; B01D 2259/4566; F01N 2330/32

(57) ABSTRACT

An exhaust gas purification device configured to improve a purification efficiency by reducing the effect of the boundary film. The exhaust gas comprises a flow path in which the catalyst is formed at least on an inner surface, and the flow path includes an inner wall surface extending in a flowing direction of an exhaust gas. A length of the flow path in the flowing direction is set to a length calculated using the equation

$$Le = {\{ dH / 9.28 \cdot √ ( ρ \cdot u / μ ) \}}^{2}$$

or shorter, where dH is a hydraulic diameter (m), ρ is a density (kg/m³) of the exhaust gas, u is a flow rate (m/s) of the exhaust gas, and μ is a viscosity (Pas) of the exhaust gas.

### CROSS-REFERENCE TO RELATED APPLICATIONS

The present disclosure claims the benefit of Japanese Patent Application No. 2024-188006 filed on Oct. 25, 2024 with the Japanese Patent Office, the disclosures of which are incorporated herein by reference in its entirety.

### BACKGROUND

### Field of the Disclosure

The embodiment of the present disclosure relates to a device for purifying exhaust gas resulting from burning fuel by removing pollutants from the exhaust gas, and more particularly, to a device for purifying exhaust gas by oxidizing or reducing pollutants using a catalyst.

### Discussion of the Related Art

Since the catalyst is expensive, it is preferable to improve purification efficiency of the exhaust gas by the catalyst as much as possible. The purification efficiency may be improved by promoting contact of the exhaust gas with the catalyst or diffusion of the exhaust gas toward the catalyst. On a surface of a flow path of the exhaust gas, a boundary film in which a laminar flow is maintained is created. The boundary film disturbs the dissipation of the exhaust gas or the pollutants toward the catalyst; therefore, it is desirable to reduce the diffusion resistance of the boundary film to improve the purification efficiency.

JP-A-H11-290699 discloses a honeycomb catalyst configured to reduce a diffusion resistance of the boundary film. The honeycomb catalyst described in JP-A-H11-290699 has a plurality of flow paths extending parallel to one another, and a plurality of cut parts crossing the flow paths are formed at intervals of 300 mm or less.

According to the descriptions of JP-A-H11-290699, the diffusion resistance of the boundary film may be reduced by reducing a length of the catalyst to an extent that a velocity boundary layer of a gaseous flow does not develop sufficiently, but the length of the flow path by which the velocity boundary layer develops is unknown. Therefore, in the honeycomb catalyst described in JP-A-H11-290699, the distance between the cut parts is set to 300 mm or less based on a relation between a honeycomb length and a mass transfer coefficient found by experiment. However, the boundary film starts developing as soon as the exhaust gas enters the flow path, and most of the flow paths having a length of 300 mm will be filled with the boundary film. That is, the technique disclosed in JP-A-H11-290699 is applied to a large honeycomb denitration catalyst for purifying the exhaust gas which is emitted from e.g., factories, and whose composition and emission amount fall within specific ranges. The catalyst of this kind may improve the diffusion of the exhaust gas toward the catalyst. However, such improvement of the diffusion of the exhaust gas is not achieved by reducing the effect of the boundary film by the catalyst described in JP-A-H11-290699, and at least the diffusion resistance of the boundary film is not reduced by the catalyst described in JP-A-H11-290699. That is, the techniques described in JP-A-H11-290699 may not be generalized. For example, exhaust gas emitted from an internal combustion engine whose composition, an emission amount, pollutants contained therein etc. are different from those of the industrial exhaust gasses may not be purified effectively by the catalyst described in JP-A-H11-290699.

### SUMMARY

The embodiment of the present disclosure has been conceived noting the foregoing technical problems, and it is therefore an object of the present disclosure to provide an exhaust gas purification device configured to improve a purification efficiency by reducing the effect of the boundary film.

According to the exemplary embodiment the present disclosure, there is provided an exhaust gas purification device that oxidizes or reduces pollutants contained in an exhaust gas by bringing the exhaust gas resulting from combustion into contact with a catalyst. The exhaust gas purification device comprises a flow path for flowing the exhaust gas therethrough in which the catalyst is formed at least on an inner surface thereof, and the flow path includes an inner wall surface extending in a flowing direction of the exhaust gas. In order to solve the above-explained technical problems, according to the exemplary embodiment of the present disclosure, a length of the flow path as a length of the inner wall surface in the flowing direction of the exhaust gas is set to a length calculated using the following equation

$$Le = {\{ dH / 9.28 \cdot √ ( ρ \cdot u / μ ) \}}^{2}$$

or shorter, where dH is a hydraulic diameter (m), ρ is a density (kg/m3) of the exhaust gas, u is a flow rate (m/s) of the exhaust gas, and μ is a viscosity (Pas) of the exhaust gas.

In a non-limiting embodiment, a lower limit of the length of the flow path may be set to a length L1 calculated using the following equations:

$$L 1 = dH / λ \cdot {\{ ( 1 / Cc ) - 1 \}}^{2} ; and$$

$$Cc = 0.582 + 0.0418 / ( 1.1 - {D}_{2} / {D}_{1} ) ,$$

where dH is the hydraulic diameter (m), λ is a coefficient of friction of the flow path, Cc is a coefficient of contraction, D₁ is a diameter (m) of the flow path before contraction, and D₂ is a diameter (m) of the flow path after contraction.

In a non-limiting embodiment, the flow path may include an opening continuing in the flowing direction that is formed in at least a portion of a periphery of a plane perpendicular to the flowing direction.

In a non-limiting embodiment, the exhaust gas purification device may further comprise a catalyst carrier as a thin flat plate in which a plurality of the flow paths are formed in parallel to one another in a plurality of rows, and each of the flow paths may penetrate through the catalyst carrier in a thickness direction. A plurality of the catalyst carriers may be are stacked in the flowing direction of the exhaust gas, and the catalyst carriers may be stacked such that the flow paths of the predetermined catalyst carrier and the flow paths of another catalyst carrier adjoining thereto are offset in a direction perpendicular to the flowing direction of the exhaust gas.

In a non-limiting embodiment, the exhaust gas purification device may further comprise an expanded mesh in which a plurality of the flow paths are formed in a grid pattern. A plurality of the expanded meshes may be stacked in the flowing direction of the exhaust gas, and the expanded meshes may be stacked such that the flow paths of the predetermined expanded mesh and the flow paths of another expanded mesh adjoining thereto are offset in a direction perpendicular to the flowing direction of the exhaust gas.

In a non-limiting embodiment, the exhaust gas purification device may further comprise a plurality of corrugated plates, and the corrugated plates are stacked such that a plurality of linear spaces through which the exhaust gas flows are formed between each pair of the stacked corrugated plates. A plurality of slits intersecting the linear spaces may be formed on the corrugated plates, and a portion of the linear space between the slits may serve as the flow path.

In a non-limiting embodiment, the exhaust gas purification device may further comprise a flat partition plate interposed between the corrugated plates.

In a non-limiting embodiment, the exhaust gas purification device may further comprise: a corrugated plate in which a plurality of channels and a plurality of beads are formed alternately; and a flat partition plate in which a plurality of through holes are formed at regular intervals. A plurality of the corrugated plates and a plurality of the flat partition plates may be stacked alternately, and a portion between the through holes extending in the flowing direction may serve as a wall portion of the flow path. A length of the flow path may be set to the length Le calculated using the foregoing equation or shorter, and the flow path may be formed by the channel or the beads of the corrugated plate and the wall portion of the partition plate.

Thus, according to the exemplary embodiment of the present disclosure, a length of the flow path is restricted to a length by which the flow path is filled with the boundary film. According to the exemplary embodiment of the present disclosure, therefore, a portion of the flow path where a diffusion of the exhaust gas toward the catalyst is restricted or limited is reduced. In other words, the catalyst is allowed to function efficiently. For this reason, a purification efficiency of the exhaust gas purification device may be improved.

As described, according to the exemplary embodiment of the present disclosure, the lower limit of the length of the flow path is set to the length obtained based on the hydraulic diameter, the coefficient of friction of the flow path, the coefficient of contraction, the diameter of the flow path before contraction, and the diameter of the flow path after contraction. According to the exemplary embodiment of the present disclosure, therefore, a contraction zone in which a turbulent flow of the exhaust gas is created in the vicinity of an entrance of the flow path and a growth zone in which a boundary film growth may be ensured. For this reason, the diffusion of the exhaust gas toward the catalyst may be expedited thereby improving the purification efficiency.

By forming the opening in a predetermined side of the flow path at least partially, an inertial resistance derived from a change in a cross-sectional area of the flow path and a resultant energy loss may be reduced.

As also described, according to the exemplary embodiment of the present disclosure, the catalyst carriers may be stacked in such a manner that the flow paths of the predetermined catalyst carrier and the flow paths of another catalyst carrier adjoining thereto are offset in a direction perpendicular to the flowing direction of the exhaust gas. In this case, the exhaust gas passing through a predetermined flow path collides against an end portion of the wall portion of the subsequent flow path, and as a result, the flowing direction or a streamline of the exhaust gas is inflected. Consequently, a turbulent flow of the exhaust gas is created so that the exhaust gas is brought into contact with the catalyst effectively to improve the purification efficiency.

Moreover, according to the exemplary embodiment of the present disclosure, the flow path may be formed using the expanded mesh or the corrugated plate. That is, the exhaust gas purification device according to the exemplary embodiment of the present disclosure may be manufactured using existing components manufactured by the conventional techniques. For this reason, the exhaust gas purification device may be manufactured easily, and in addition, a manufacturing cost of the exhaust gas purification device may be reduced.

Further, in the case of forming the linear spaces through which the exhaust gas flows by combining the corrugated plates, each portion between the slits intersecting the linear spaces serves as the flow path. In this case, the flow path whose length is limited to the length by which the boundary film is not created excessively may be formed easily.

In addition, according to the exemplary embodiment of the present disclosure, the lengths of the flow paths may also be restricted by interposing the partition plate in which the through holes are formed between the stacked corrugated plates. For this reason, the exhaust gas purification device may be manufactured easily.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a partially cut-away perspective view schematically showing an exhaust gas purification device according to the exemplary embodiment of the present disclosure;

FIG. 2 is a schematic view showing stacked catalyst carriers;

FIG. 3 is a perspective view showing a part of an expanded metal mesh as a base material;

FIG. 4 is a perspective view partially showing an upper shearing die and a lower shearing die for manufacturing the expanded metal mesh;

FIG. 5 is a cross-sectional view showing a cross-section of the expanded metal mesh along the V-V line drawn in FIG. 3;

FIG. 6 is an enlarged cross-sectional view showing a cross-section of the expanded metal mesh and the catalyst adhering thereto;

FIG. 7 is a partial front view showing the base materials stacked in the flowing direction of the exhaust gas in such a manner that flow paths are offset from one another;

FIG. 8 is a model diagram of the flow path showing an entrance length;

FIG. 9 is a model diagram of the flow path sowing a contraction zone;

FIG. 10 is a graph showing a measuring result of a relation between: a ratio between a contact property and the pressure loss; and a length of the flow path;

FIG. 11 is a model diagram showing the flow path having an opening;

FIG. 12 is a partial perspective view showing a stack of the corrugated plates;

FIG. 13 is a cross-sectional view showing the stack of corrugated plates rounded to be housed in a casing;

FIG. 14 is a partial perspective view showing the corrugated plates and the partition plates stacked alternately; and

FIG. 15 is a partial plan view showing the partition plate having through-holes laid on the corrugated plate.

### DETAILED DESCRIPTION OF THE PREFERRED EMBODIMENT(S)

The exemplary embodiment of the present disclosure will now be explained with reference to the accompanying drawings. Note that the embodiment shown below is merely an example of the present disclosure, and do not limit the present disclosure.

The present disclosure relates to a device for purifying various kinds of exhaust gas resulting from combustion including exhaust gas emitted from a vehicular engine. In order to purify the exhaust gas, the exhaust gas purification device is provided with a catalyst for oxidizing or reducing pollutants contained in the exhaust gas such as carbon monoxide, hydrocarbons, and nitrogen oxides to detoxify those pollutants.

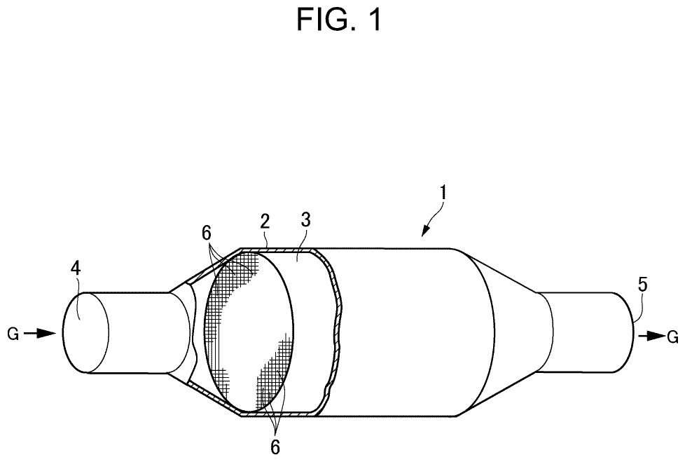

Referring now to FIG. 1, there is shown an exhaust gas purification device 1 according to the exemplary embodiment of the present disclosure. As illustrated in FIG. 1, in the exhaust gas purification device 1, catalyst carriers 3 are housed in a casing 2. Specifically, the casing 2 is a hollow cylindrical body including a circular cylinder, an elliptical cylinder, and a polygonal cylinder. In the casing 2, an inlet 4 is formed on one of axial ends, and an outlet 5 is formed on the other axial end. An exhaust gas G introduced into the exhaust gas purification device 1 from the inlet 4 passes through the catalyst carriers 3 so that the pollutant such as carbon monoxide contained in the exhaust gas G is oxidized or reduced to be detoxified.

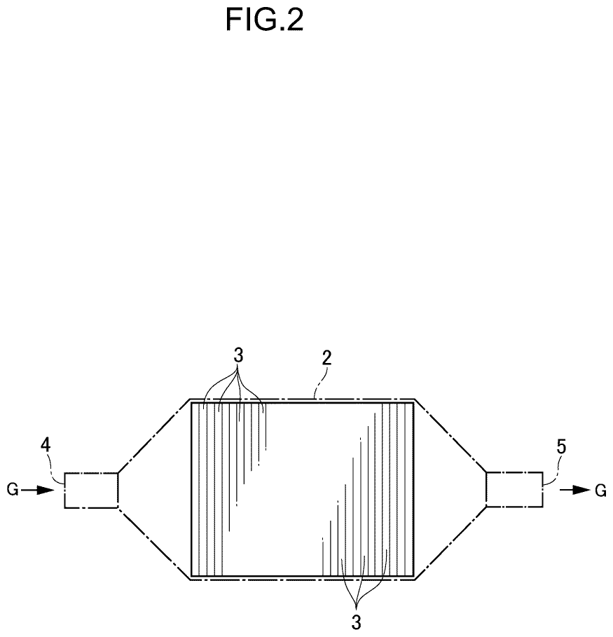

Each of the catalyst carrier 3 has a plurality of flow paths 6 as through holes penetrating through the catalyst carrier 3 in the thickness direction of the catalyst carrier 3, and the exhaust gas G introduced into the exhaust gas purification device 1 passes through the flow paths 6 to be purified. As illustrated in FIG. 2, the catalyst carrier 3 is shaped into a thin flat plate, and a plurality of the catalyst carriers 3 are stacked in the casing 2 in a flowing direction of the exhaust gas G. The catalyst carriers 3 arranged in the casing 2 may be in close contact with one another. Otherwise, the catalyst carriers 3 may be arranged in the casing 2 while maintaining a predetermined space therebetween. Specifically, in the catalyst carrier 3, a plurality the flow paths 6 are formed in parallel to one another in a plurality of rows. In order to purify the exhaust gas G effectively, the number of the flow paths 6, and a ratio of a total area of the flow paths 6 to a surface area of the catalyst carrier 3 are preferably large as much as possible. To this end, according to the exemplary embodiment of the present disclosure, an expanded metal mesh is adopted as a base material 7 of the catalyst carrier 3.

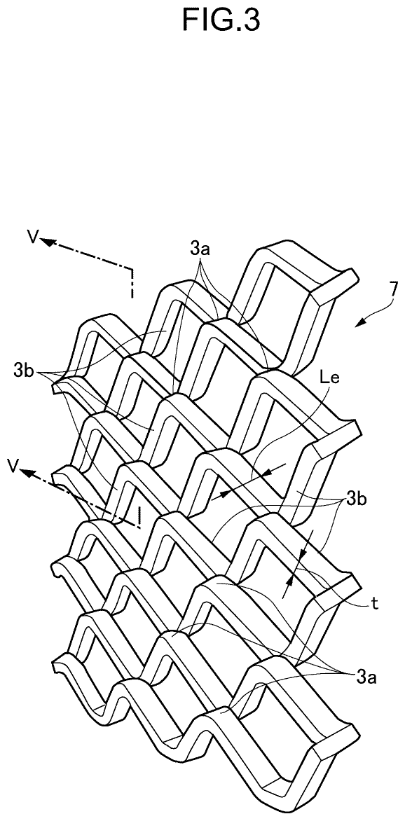

A structure of the base material 7 is partially shown in FIG. 3. The base material 7 may be manufactured by a conventionally known device and method. For example, the base material 7 is formed by shearing a plurality of portions of a metal sheet material at a constant pitch in a direction perpendicular to a feeding direction of the metal sheet material in an alternately staggered manner at respective strokes. As a result, slits formed on the metal sheet material are stretched in the feeding direction so that a plurality of rectangular or rhombus shaped openings are formed in the metal sheet material in a grid pattern. In the base material 7 thus formed, uncut portions between the slits serve as connections 3a.

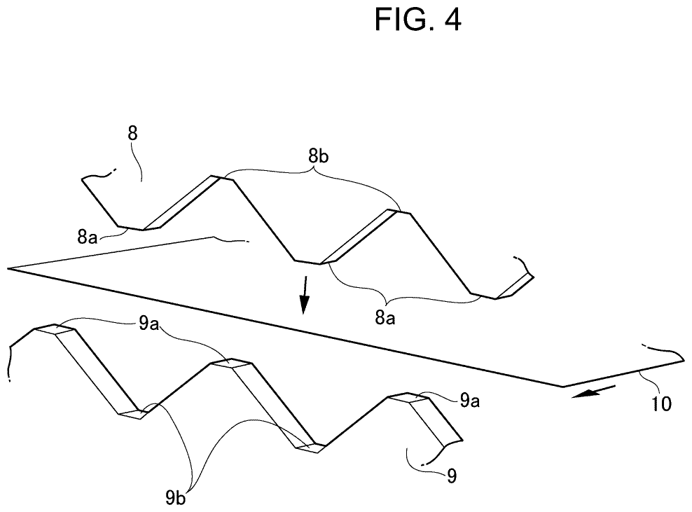

According to the exemplary embodiment of the present disclosure, the base material 7 is formed by shearing a metal sheet 10 intermittently using an upper shearing die 8 and a lower shearing die 9 shown in FIG. 4 while feeding the metal sheet 10 in a direction indicated by the arrow in FIG. 4. In the upper shearing die 8, teeth 8a and valleys 8b are formed alternately, and in the lower shearing die 9, teeth 9a and valleys 9b are formed alternately. Thus, structures of the upper shearing die 8 and the lower shearing die 9 are similar to each other. The upper shearing die 8 and the lower shearing die 9 are opposed to each other in the vertical direction such that the teeth 8a of the upper shearing die 8 and the valleys 9b of the lower shearing die 9 are slightly offset from each other in the feeding direction of the metal sheet 10. Firstly, the metal sheet 10 is advanced by a predetermined amount to be fed between the upper shearing die 8 and the lower shearing die 9, and the upper shearing die 8 is moved downwardly. Consequently, a row of slits is formed in the metal sheet 10 by slant faces of teeth 8a and the valleys 9b in the direction perpendicular to the feeding direction of the metal sheet 10. In this situation, portions of the metal sheet 10 clamped between top lands of the teeth 9a and bottom lands of valleys 8b are not sheared and shaped into the connections 3a. Subsequently, the upper shearing die 8 is lifted while being moved transversely, and the metal sheet 10 is advanced by the predetermined amount again. Thereafter, the upper shearing die 8 is lowered again so that another row of slits is formed on the metal sheet 10 in alternately staggered manner. By repeating the foregoing procedures, the expanded metal mesh as the base material 7 of the catalyst carrier 3 shown in FIG. 3 is formed.

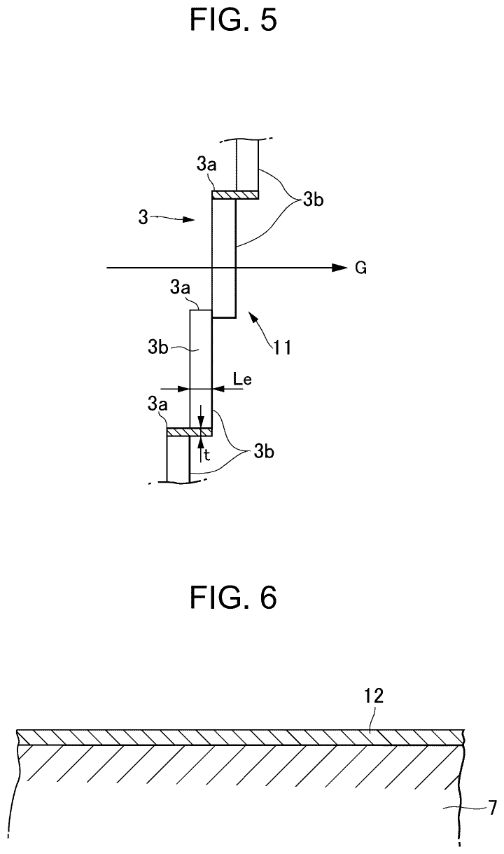

FIG. 5 is a cross-sectional view of the catalyst carrier 3 along a plane perpendicular to the connections 3a. As shown in FIG. 5, a strand 3b is formed between the connections 3a, and a width (i.e., a length) Le of the strand 3b corresponds to a feeding amount of the metal sheet 10 per one stroke of the upper shearing die 8. Each space enclosed by the strands 3b and the connections 3a serves as a flow path 11, and the exhaust gas G flows through the flow paths 11 along inner and outer wall surfaces of the connections 3a and the strand 3b in the thickness direction of the catalyst carrier 3 (i.e., the horizontal direction in FIG. 5). Thus, the base material 7 of the catalyst carrier 3 is an expanded metal mesh in which a plurality of flow paths 11 are formed. As described, the feeding amount of the metal sheet 10 with respect to one stroke of the upper shearing die 8 corresponds to the length Le of the flow path 11 enclosed by the inner and outer wall surfaces of the connections 3a and the strand 3b. In FIG. 5, the reference character “t” represents a thickness of the metal sheet 10.

As schematically illustrated in FIG. 6, a catalyst 12 is adheres to the surface of the flow path 11, that is, the catalyst 12 is formed on the surface of the base material 7. According to the exemplary embodiment of the present disclosure, the catalyst 12 may be formed of a known catalyst material such as platinum Pt or rhodium Rh.

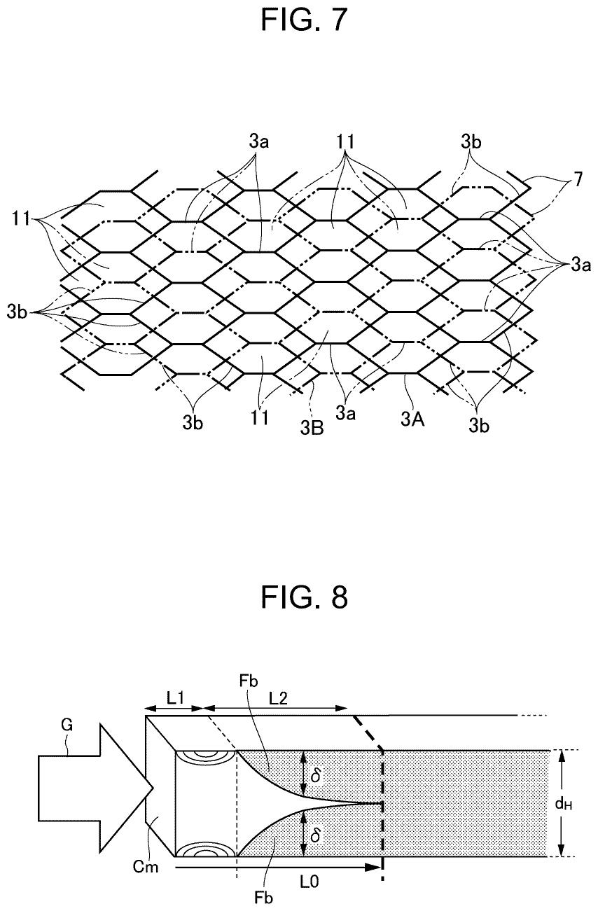

As shown in FIG. 5, the catalyst carrier 3 is erected perpendicularly to the center axis of the casing 2, that is, to the flowing direction of the exhaust gas G. However, in the base material 7 as an expanded metal mesh, the strands 3b are offset at step by step in the feeding direction of the metal sheet 10 during the shearing process of the metal sheet 10. Therefore, the catalyst carriers 3 may also be stacked obliquely in the casing 2. In this case, the length Le of each of the flow paths 6 is elongated slightly longer than the feeding amount of the metal sheet 10 with respect to one stroke of the upper shearing die 8. In addition, as shown in FIG. 7, it is preferable to juxtapose the catalyst carriers 3 such that the flow paths 11 are offset from one another. According to the example shown in FIG. 7, the predetermined catalyst carrier 3A illustrated by the solid lines and the adjoining catalyst carrier 3B illustrated by the dotted lines are arranged such that the flow paths 11 of the catalyst carriers 3A and 3B are offset in the radial direction of the casing 2, i.e., in the direction perpendicular to the flowing direction of the exhaust gas G. In other words, the connections 3a of the adjoining catalyst carrier 3B are located at entrances or exits of the flow paths 11 of the predetermined catalyst carrier 3A. Therefore, the flow of the exhaust gas G flowing out of flow paths 11 of the predetermined catalyst carrier 3A is disturbed at the entrances of the flow paths 11 of the adjoining catalyst carrier 3B.

According to the exemplary embodiment of the present disclosure, the length Le of the flow path 11 is set taking account of a diffusion resistance governed by a boundary film. FIG. 8 is a model diagram for explaining a flow of the exhaust gas G flowing through a flow path Cm having a rectangular cross-section. As illustrated in FIG. 8, an effective cross-sectional area of the exhaust gas G flowing into the flow path Cm is restricted by the flow path Cm, and hence a flow condition of the exhaust gas G is changed. In other words, the effective cross-sectional area of the exhaust gas G is contracted to an inner perimeter of the flow path Cm. Consequently, a turbulent flow of the exhaust gas G is created in the vicinity of the entrance of the flow path Cm. The turbulent flow of the exhaust gas G abates gradually with the progress of the exhaust gas G in the flow path Cm, and eventually turns into a laminar flow. In a contraction zone L1 from the entrance of the flow path Cm as a starting point of the turbulent flow to a starting point of the laminar flow, the exhaust gas G repeatedly comes into contact with the catalyst 12 supported on the inner surface of the flow path Cm, and repeatedly flows away from the catalyst 12. As a result, the exhaust gas G is diffused effectively on the catalyst 12.

After the exhaust gas G passes through the contraction zone L1, the flow of the exhaust gas G becomes stable. Eventually, the boundary film Fb grows gradually and the exhaust gas G turns into the laminar flow. Consequently, a thickness δ of the boundary film Fb increases gradually, and eventually the flow path Cm is filled with the boundary film Fb. That is, the boundary film Fb grows in a growth zone L2 from a point at which the boundary film Fb is created to a point at which the flow path Cm is completely filled with the boundary film Fb, and after the exhaust gas G passes through the growth zone L2, the exhaust gas G or the contaminant is hardly diffused on the catalyst 12 supported on the inner surface of the flow path Cm. That is, the purification of the exhaust gas G is not expedited.

The thickness δ of the boundary film Fb may be estimated using the following equation (1):

$$δ = 4.64 \sqrt{\frac{μ}{ρ u}} \sqrt{L} \qquad ( 1 )$$

where ρ is a density (kg/m³) of the exhaust gas, u is a flow rate (m/s) of the exhaust gas, μ is a viscosity (Pas) of the exhaust gas, and L is a length of the flow path.

As can be seen from FIG. 8, the flow path Cm is completely filled with the boundary film Fb in a situation where the thickness δ of the boundary film Fb increases to half the hydraulic diameter dH of the flow path Cm (dH/2). As described, in the situation where the internal space of the flow path Cm is filled with the boundary film Fb, the exhaust gas G may not be purified effectively by the catalyst 12. That is, the exhaust gas G may be purified effectively by the catalyst 12 within an entrance length L0 as a total length of the contraction zone L1 and the growth zone L2 shown in FIG. 8. According to the exemplary embodiment of the present disclosure, therefore, the entrance length L0 is adopted as an upper limit of the length Le of the flow path Cm. In other words, the length Le of the flow path Cm is limited to entrance length L0 or less. Specifically, the length Le of the flow path Cm may be obtained by substituting (dH/2) for the thickness δ in the equation (1) and transforming the equation (1) into the following equation (2).

$$Le = {( \frac{dH}{2 \times 4.64} \sqrt{\frac{ρ u}{μ}} )}^{2} \qquad ( 2 )$$

The hydraulic diameter dH employed in the equation (2) may be geometrically obtained based on the configuration of the flow path 11 of the catalyst carrier 3. Specifically, the hydraulic diameter dH may be calculated based on a cross-sectional area Ac and a perimeter Lr of the flow path Cm as expressed by the following expression:

$$dH = 4 \cdot Ac \cdot Lr .$$

Accordingly, the entrance length L0 may be calculated by measuring the density ρ, the flow rate u, and the viscosity μ of the exhaust gas G, and substituting these parameters into the equation (2).

In the contraction zone L1, the dissipation of the exhaust gas G is expedited, but a pressure loss also occurs. As described above, the entrance length L0 employed as the length Le of the flow path Cm includes the contraction zone L1. Therefore, it is preferable to set the length Le of the flow path Cm taking account of the pressure loss, the diffuseness of the exhaust gas G, and the contacting property of the exhaust gas G with the inner surface of the flow path Cm. The length of the contraction zone L1 may be generally expressed as the following equation (3):

$$L 1 = \frac{dH}{λ} {( \frac{1}{Cc} - 1 )}^{2} \qquad ( 3 )$$

where λ is a coefficient of friction (=64/Re, Re is the Reynolds number) of the flow path, and Cc is a coefficient of contraction. Given that an outer diameter of the flow path before the contraction is D1 and that an inner diameter of the flow path after the contraction is D2, the coefficient Cc of contraction may be obtained using the following equation (4).

$$Cc = 0.5282 + \frac{0.0418}{1.1 - ( \frac{D 2}{D 1} )} \qquad ( 4 )$$

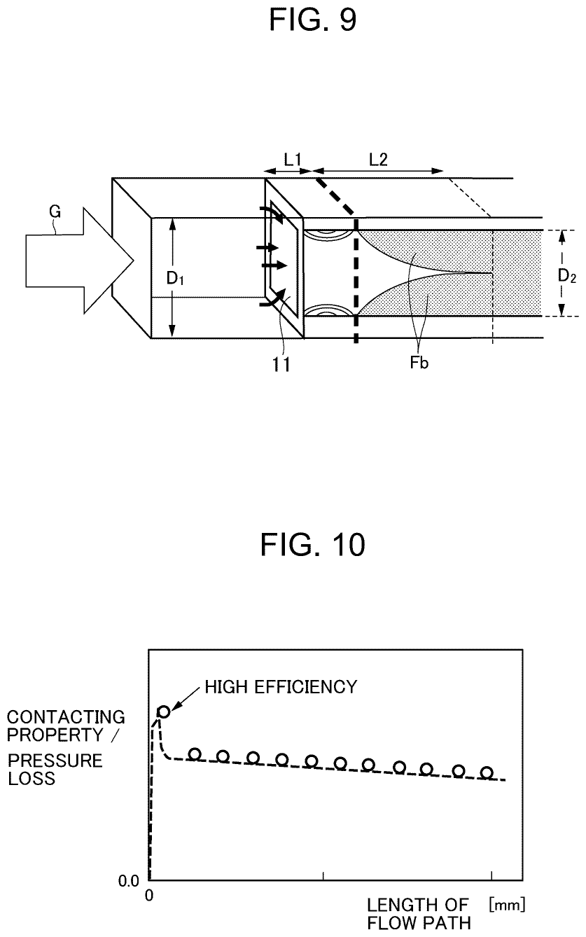

The contraction zone L1, the outer diameter D1 of the flow path 11 before the contraction, and the inner diameter D2 after the contraction are modeled in FIG. 9.

According to the exemplary embodiment of the present disclosure, the length Le of the flow path 11 includes the contraction zone L1, and the length of the contraction zone L1 is governed by a structure of the flow path 11 and the composition of the exhaust gas G. Therefore, if the length Le of the flow path 11 is set shorter than the entrance lengthL0, the growth zone L2 is shortened thereby reducing the contacting property of the exhaust gas G with the catalyst 12. Specifically, the definition of the “contacting property” is a frequency (i.e., the number of times) that the pollutant contained in the exhaust gas G comes into contact with the surface of the catalyst 12 per unit time. The length Le of the flow path 11 by which the pressure drop is reduced and the contacting property is improved to maximize the purification efficiency of the exhaust gas G may be found within a range between the contraction zone L1 and the upper limit of the entrance length L0. FIG. 10 shows a measurement result of a relation between: a ratio between the contacting property and the pressure loss; and the length Le of the flow path 11. If the ratio between the contact property and the pressure loss is large, the diffusion of the exhaust gas G toward the catalyst 12 is promoted thereby improving the purification efficiency of the exhaust gas G, even if the pressure loss as the energy loss occurs. As can be seen from FIG. 10, if the length Le of the flow path 11 is short, the ratio between the contacting property and the pressure loss (that is, the purification efficiency) increases significantly. By increasing the length Le of the flow path 11 from the length at which the purification efficiency increases to the highest value, the purification efficiency decreases significantly from the highest value to a predetermined value, and further decreases gradually with a further increase in the length Le of the flow path 11. As described above, the exhaust gas G diffuses in both of the contraction zone L1 and the growth zone L2, and the contacting property decreases gradually in the growth zone L2 toward the front section in the flowing direction of the exhaust gas G. Therefore, the length of the contraction zone L1 is adopted as a lower limit of the length Le of the flow path 11.

FIG. 9 shows a pressure loss occurring in the predetermined flow path 11 in which a cross-sectional area thereof is reduced. However, in the exhaust gas purification device 1, a plurality of the flow paths 11 are juxtaposed in the flowing direction of the exhaust gas G. Therefore, the pressure loss and the resistance are induced not only by a contraction of the cross-sectional area of the flow path, but also by an enlargement of the cross-sectional area of the flow path or an inflection of a streamline of the exhaust gas G. The pressure loss ΔP due to a change in the cross-sectional area of the flow path, a collision of the exhaust gas G and so on may be expressed generally by the following equation (5)

$$Δ P = ( λ \frac{\sum L}{{d}_{H}} + \sum {K}_{i} ) \frac{ρ}{2} {u}^{2} \qquad ( 5 )$$

where A is a coefficient of friction (=64/Re, Re is the Reynolds number <2300), Ki is a coefficient of inertial resistance, and i is an expansion or contraction of the cross-sectional area of the flow path, a collision of the exhaust gas G and an inflection of the streamline, and a change point of the flow of the exhaust gas G such as an outlet of the flow path.

In order to guide the exhaust gas G and to restrict the flow of the exhaust gas G, the flow path 11 encloses a predetermined space. Therefore, a region where the exhaust gas G flows or a cross-sectional area of the exhaust gas G changes after passing through the flow path 11. If the cross-sectional area of the flow path changes significantly, the coefficient of inertial resistance is increased thereby increasing the pressure loss ΔP. Since the flow path 11 shown in FIG. 9 is shaped into a rectangular pipe in which all sides are closed, a pressure of the exhaust gas G flowing through the flow path 11 is changed significantly by a contraction or an enlargement of the cross-sectional area of the flow path 11. In order to reduce such change in the pressure, according to the example shown in FIG. 11, an opening Op is formed in a predetermined side of the flow path 11A along the streamline F of the exhaust gas G at least partially. Whereas, according to the example shown in FIGS. 3 and 5, the upper two sides of the flow path 11 are open. In other words, according to the exemplary embodiment of present disclosure, the opening continuing in the flowing direction of the exhaust gas G is formed in at least a portion of the periphery of a plane perpendicular to the flowing direction of the exhaust gas G. According to the exemplary embodiment of present disclosure, therefore, the above-mentioned pressure loss may be reduced. In addition, the diffusion of the exhaust gas G toward the catalyst 12 may be promoted, and the contact frequency of the exhaust gas G with the catalyst 12 may be increased.

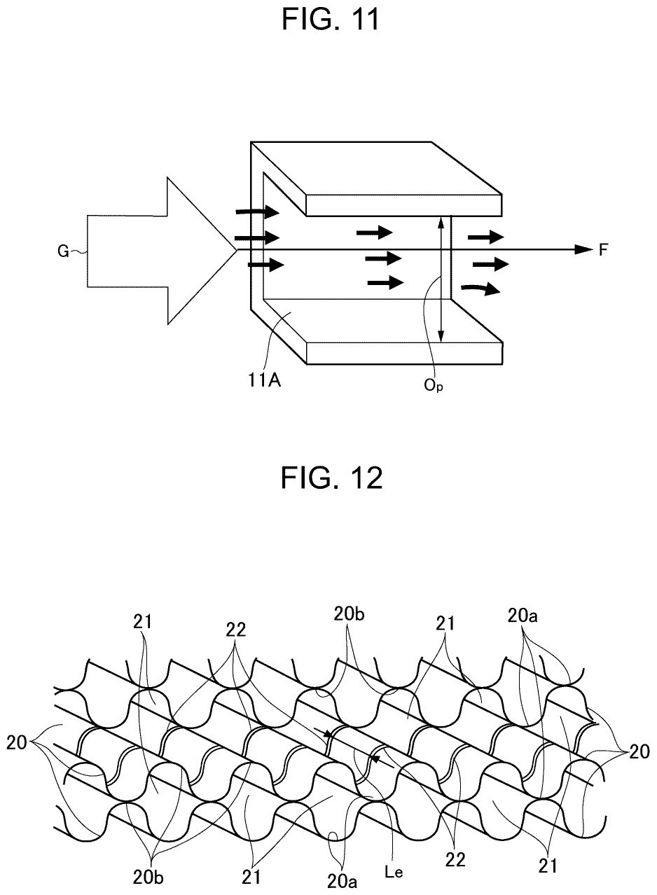

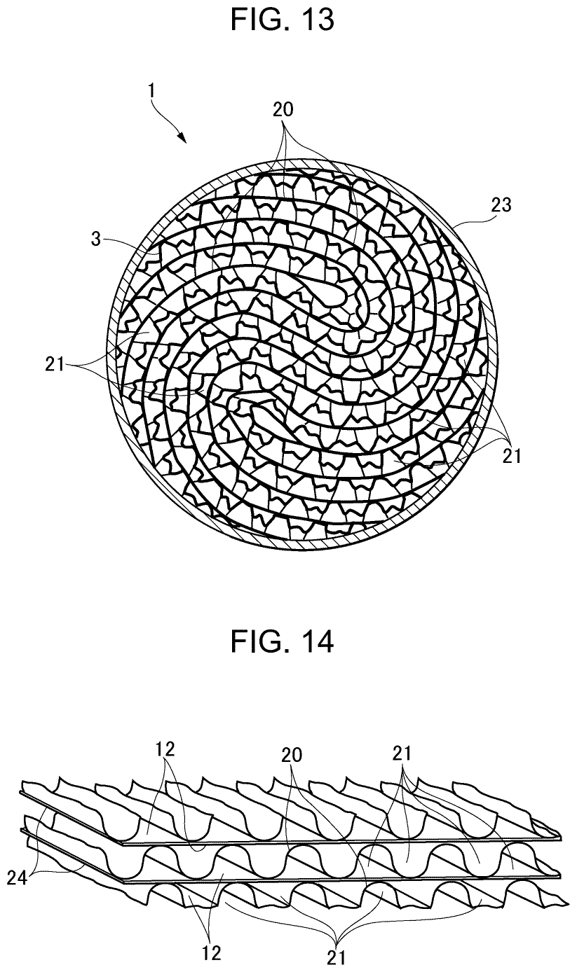

The flow path according to the exemplary embodiment of the present disclosure embodiment may also be formed using a material other than the expanded metal mesh. In the examples shown in FIGS. 12 and 13, a metal corrugated plate 20 in which the catalyst 12 is attached to a surface thereof is employed as the base material. In each corrugated plate 20, channels 20a and beads 20b are formed alternately, and the corrugated plates 20 are stacked such that the channels 20a and the beads 20b are offset by half pitch. Consequently, in each pair of the stacked corrugated plates 20, a plurality of linear spaces serving as the flow paths 21 are formed by the channels 20a (or beads 20b) of one of the corrugated plates 20 and the opposed beads 20b (or channels 20a) of the other corrugated plate 20.

In the example shown in FIGS. 12 and 13, a plurality of slits (or cutouts) 22 are formed on the corrugated plates 20 in a direction intersecting the flow paths 21 enclosed by the channels 20a and the beads 20b. Specifically, the slits 22 are formed at regular intervals in the longitudinal direction of the flow path 21 or in the flowing direction of the exhaust gas G. The slits 22 may not be aligned in the direction perpendicular to the longitudinal direction of the flow channel 21, but may be offset from one another in the longitudinal direction of the flow channel 21. The flow paths 21 are defined by the slits 22, that is, the length Le of the flow path 21 is determined by the slits 22. Specifically, as the foregoing examples, the length Le of the flow path 21 is set to the contraction zone L1 or longer but to the entrance length L0 or shorter.

As illustrated in FIG. 13, in order to form the exhaust gas purification device 1, the stack of the corrugated plates 20 is rounded to have a circular or an elliptical cross-sectional shape, and is accommodated in the casing 23.

As illustrated in FIG. 14, the flow paths 21 may also be formed by combining the corrugated plate 20 and a flat partition plate 24 made of metal. The corrugated plate 20 shown in FIG. 14 also has a plurality of slits formed at intervals narrower than the entrance length L0, and the corrugated plates 20 thus structured and the partition plates 24 are stacked alternately to form the flow paths 21. That is, the entrance length L0 is the upper limit value of the intervals between the slits. According to the example shown in FIG. 14, the catalyst 12 is attached to both top and bottom surfaces of the partition plate 24.

According to the example shown in FIG. 14, in the predetermined corrugated plate 20, the channels 20a formed on the top surface are closed by the partition plate 24 attached to tips of the beads 20b formed alternately on the top surface so that the channels 20a formed on the top surface serve as the flow paths 21. Likewise, in the predetermined corrugated plate 20, the channels 20a formed on the bottom surface are also closed by another partition plate 24 attached to tips of the beads 20b formed alternately on the bottom surface so that the channels 20a formed on the bottom surface also serve as the flow paths 21. Thus, the flow paths 21 are formed on both surfaces of the corrugated plate 20. According to the example shown in FIG. 14, the length Le of the flow path 21 is also set to the entrance length L0 or shorter by forming the slits shown in FIG. 12. The stack of the corrugated plates 20 and the partition plate 24 is also rounded to have a circular or an elliptical cross-sectional shape, and is accommodated in the casing to form the exhaust gas purification device 1.

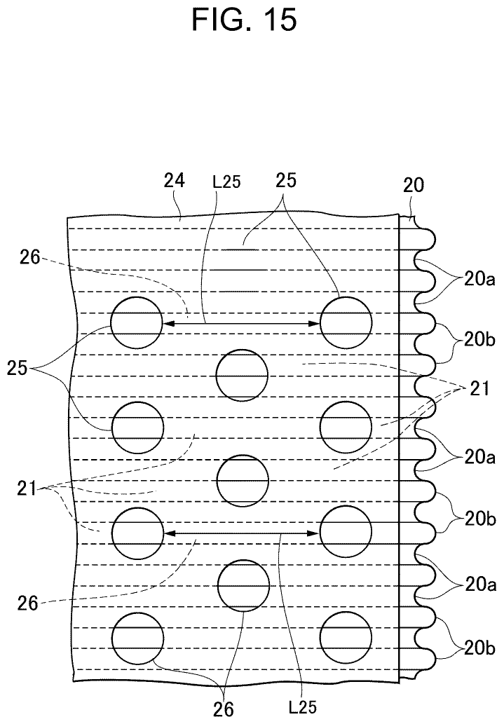

In the case of forming the flow paths 21 by combining the corrugated plates 20 and the partition plates 24, the length Le of each of the flow paths 21 may also be set by forming through holes 25 on the partition plate 24 instead of the slits. In this case, as illustrated in FIG. 15, a plurality of through holes 25 are formed on the partition plate 24 at regular intervals. For example, the through hole 25 may be formed into a circular shape as shown in FIG. 15. Instead, the through hole 25 may also be formed into a rectangular shape, a polygonal shape, a thin line shape and so on. According to the example shown in FIG. 15, a clearance L25 between the through holes 25 in the longitudinal direction of the channel 20a of the corrugated plate 20 is set to the entrance length L0 or shorter.

In the example shown in FIG. 15, the flow paths 21 formed by the channels 20a of the corrugated plate 20 and the partition plate 24 open to any of the surfaces of the partition plate 24 through the through holes 25. That is, the flow path closed by the partition plate 24 is interrupted by the through hole 25. That is, according to the example shown in FIG. 15, a portion between the through holes 25 serves as a wall portion 26, and the flow path 21 is formed by the channel 20a of the corrugated plate 20 and the wall portion 26 of the partition plate 24. According to the example shown in FIG. 15, the length Le of the flow path 21 is set to the entrance length L0 corresponding to the clearance between the through holes 25 or shorter. The stack of the corrugated plates 20 and the partition plate 24 shown in FIG. 15 is also rounded to have a circular or an elliptical cross-sectional shape, and is accommodated in the casing to form the exhaust gas purification device 1.

In the exhaust gas purification device 1 having the corrugated plate 20 shown in FIGS. 12 to 15, the length Le of the flow path is also set to the length obtained by the above-mentioned expression (2). Therefore, the portion where the diffusion of the exhaust gas G is hampered is reduced so that the catalyst 12 is allowed to function effectively. In other words, useless portions of the flow paths and the catalyst may be omitted, and as a result, the purification efficiency of the exhaust gas G is improved.

As described, according to the exemplary embodiment of the present disclosure, the length Le of the flow path is determined based on a density, a viscosity, and a flow rate of the exhaust gas to be purified. However, measurement values of those factors may contain slight errors depending on a measuring method, a measurement environment and so on. Therefore, taking account of such measurement errors, a product having a length approximately 20% longer than the length calculated using the equation (2) falls within the scope of present disclosure. In addition, the present disclosure should not be limited to the foregoing examples, and may be modified arbitrarily within the scope of disclosure. For example, it is not necessary to restrict the lengths of all of the flow paths to the length determined by the equation (2) or shorter. That is, the exhaust gas purification device having at least one flow path whose length is determined by the equation (2) or shorter falls within the scope of present disclosure.

What is claimed is:

1. An exhaust gas purification device that oxidizes or reduces pollutants contained in an exhaust gas by bringing the exhaust gas resulting from combustion into contact with a catalyst, comprising:
a flow path for flowing the exhaust gas therethrough in which the catalyst is formed at least on an inner surface thereof,
wherein the flow path includes an inner wall surface extending in a flowing direction of the exhaust gas, and
a length of the flow path as a length of the inner wall surface in the flowing direction of the exhaust gas is set to a length calculated using the following equation
$$Le = {\{ dH / 9.28 \cdot √ ( ρ \cdot u / μ ) \}}^{2}$$
or shorter, where dH is a hydraulic diameter (m), ρ is a density (kg/m³) of the exhaust gas, u is a flow rate (m/s) of the exhaust gas, and μ is a viscosity (Pas) of the exhaust gas.

2. The exhaust gas purification device as claimed in claim 1, wherein a lower limit of the length of the flow path is set to a length L1 calculated using the following equations:
$$L 1 = dH / λ \cdot {\{ ( 1 / Cc ) - 1 \}}^{2} ; and$$
$$Cc = 0.582 + 0.0418 / ( 1.1 - {D}_{2} / {D}_{1} ) ,$$
where dH is the hydraulic diameter (m), λ is a coefficient of friction of the flow path, Cc is a coefficient of contraction, D₁ is a diameter (m) of the flow path before contraction, and D₂ is a diameter (m) of the flow path after contraction.

3. The exhaust gas purification device as claimed in claim 1, wherein the flow path includes an opening continuing in the flowing direction that is formed in at least a portion of a periphery of a plane perpendicular to the flowing direction.

4. The exhaust gas purification device as claimed in claim 2, wherein the flow path includes an opening continuing in the flowing direction that is formed in at least a portion of a periphery of a plane perpendicular to the flowing direction.

5. The exhaust gas purification device as claimed in claim 1, further comprising:
a catalyst carrier as a thin flat plate in which a plurality of the flow paths are formed in parallel to one another in a plurality of rows, each of the flow paths penetrates through the catalyst carrier in a thickness direction,
wherein a plurality of the catalyst carriers are stacked in the flowing direction of the exhaust gas, and
the catalyst carriers are stacked such that the flow paths of the predetermined catalyst carrier and the flow paths of another catalyst carrier adjoining thereto are offset in a direction perpendicular to the flowing direction of the exhaust gas.

6. The exhaust gas purification device as claimed in claim 2, further comprising:
a catalyst carrier as a thin flat plate in which a plurality of the flow paths are formed in parallel to one another in a plurality of rows, each of the flow paths penetrates through the catalyst carrier in a thickness direction,
wherein a plurality of the catalyst carriers are stacked in the flowing direction of the exhaust gas, and
the catalyst carriers are stacked such that the flow paths of the predetermined catalyst carrier and the flow paths of another catalyst carrier adjoining thereto are offset in a direction perpendicular to the flowing direction of the exhaust gas.

7. The exhaust gas purification device as claimed in claim 1, further comprising:
an expanded mesh in which a plurality of the flow paths are formed in a grid pattern,
wherein a plurality of the expanded meshes are stacked in the flowing direction of the exhaust gas, and
the expanded meshes are stacked such that the flow paths of the predetermined expanded mesh and the flow paths of another expanded mesh adjoining thereto are offset in a direction perpendicular to the flowing direction of the exhaust gas.

8. The exhaust gas purification device as claimed in claim 2, further comprising:
an expanded mesh in which a plurality of the flow paths are formed in a grid pattern,
wherein a plurality of the expanded meshes are stacked in the flowing direction of the exhaust gas, and
the expanded meshes are stacked such that the flow paths of the predetermined expanded mesh and the flow paths of another expanded mesh adjoining thereto are offset in a direction perpendicular to the flowing direction of the exhaust gas.

9. The exhaust gas purification device as claimed in claim 1, further comprising:
a plurality of corrugated plates,
wherein the corrugated plates are stacked such that a plurality of linear spaces through which the exhaust gas flows are formed between each pair of the stacked corrugated plates,
a plurality of slits intersecting the linear spaces are formed on the corrugated plates, and
a portion of the linear space between the slits serves as the flow path.

10. The exhaust gas purification device as claimed in claim 2, further comprising:
a plurality of corrugated plates,
wherein the corrugated plates are stacked such that a plurality of linear spaces through which the exhaust gas flows are formed between each pair of the stacked corrugated plates,
a plurality of slits intersecting the linear spaces are formed on the corrugated plates, and
a portion of the linear space between the slits serves as the flow path.

11. The exhaust gas purification device as claimed in claim 9, further comprising:
a flat partition plate interposed between the corrugated plates.

12. The exhaust gas purification device as claimed in claim 10, further comprising:
a flat partition plate interposed between the corrugated plates.

13. The exhaust gas purification device as claimed in claim 1, further comprising:
a corrugated plate in which a plurality of channels and a plurality of beads are formed alternately; and
a flat partition plate in which a plurality of through holes are formed at regular intervals,
wherein a plurality of the corrugated plates and a plurality of the flat partition plates are stacked alternately,
a portion between the through holes extending in the flowing direction serves as a wall portion of the flow path,
a length of the flow path is set to the length Le calculated using the foregoing equation or shorter, and
the flow path is formed by the channel or the beads of the corrugated plate and the wall portion of the partition plate.

14. The exhaust gas purification device as claimed in claim 2, further comprising:
a corrugated plate in which a plurality of channels and a plurality of beads are formed alternately; and
a flat partition plate in which a plurality of through holes are formed at regular intervals,
wherein a plurality of the corrugated plates and a plurality of the flat partition plates are stacked alternately,
a portion between the through holes extending in the flowing direction serves as a wall portion of the flow path,
a length of the flow path is set to the length Le calculated using the foregoing equation or shorter, and
the flow path is formed by the channel or the beads of the corrugated plate and the wall portion of the partition plate.
